(19) United States
(12) Patent Application Publication
(10) Pub. No.: US 2015/0157041 A1
(43) Pub. Date: Jun. 11, 2015

(54) FROSTING MEDALLIONS AND RELATED METHODS OF USE

(71) Applicant: Heather Sotolongo, I, Claremont, CA (US)

(72) Inventor: Heather Sotolongo, I, Claremont, CA (US)

(21) Appl. No.: 14/103,727

(22) Filed: Dec. 11, 2013

(51) Int. Cl. A23G 3/50; A21D 13/00

(52) U.S. Cl. CPC A23G 3/50; A21D 13/0009; A23V 2002/00

(57) ABSTRACT

Disclosed are apparatus and related methods of producing professional looking and tasting cupcakes. In one embodiment, the disclosed apparatus are novel and pre-made butter cream frosting stickers for standard cupcakes. In a preferred mode of operation, the frosting sticker is applied to the top of a baked cupcake and allowed to set. In one mode of preparation, the sticker is prepared via piping frosting into a disk on a pan and freezing the disk.

### BACKGROUND OF INVENTION

1. Field of the Invention

This document describes pre-formed cupcake toppings and related methods. Specifically, this document describes frozen pre-formed cupcake toppings that may be provided to cupcakes or other baked goods.

2. Background of the Invention

Cakes are baked confections that are sometimes served as a desert after a meal or as party favors. A popular cake type—a cupcake—is a small single serving cake that is typically baked in a small paper cup that is peeled off of the cake prior to consumption. Like other types of cakes, the part of cupcakes exposed above the brim of the paper cups after baking (cupcake tops), are typically decorated with icing and other confectionary items, like sprinkles.

Usually, consumers of cupcakes enjoy cakes that are pleasing to the palate and to the eye. While untrained persons can follow the directions of a recipe for a delicious cupcake and frosting, application of the frosting to the cupcake by an untrained hand often results in non-aesthetically pleasing frosting smear instead of a desirable artwork on the cupcake top. For this reason, many people buy professionally made cupcakes. However, professionally made cupcakes may be too expensive or out of the geographical range of many potential cupcake consumers. Thus, a need exists for apparatus and related methods for untrained persons to produce professional looking cupcakes.

In view of the foregoing, many have developed pre-formed frosting or other edible films for placement on cakes. See, e.g.: U.S. Pat. Nos. 1,788,493 (issued Jan. 13, 1931), U.S. Pat. No. 3,503,345 (issued Mar. 31, 1970), U.S. Pat. No. 4,560,562 (issued Dec. 24, 1985), U.S. Pat. No. 5,035,907 (issued Jul. 30, 1991), U.S. Pat. No. 5,089,307 (issued Feb. 18, 1992), U.S. Pat. No. 6,056,982 (issued May 2, 2000), U.S. Pat. No. 6,616,958 (issued Sep. 9, 2003), and U.S. Pat. No. 6,652,897 (issued Nov. 25, 2003); and, U.S. Pub. Pat. App. Nos. 2006/0172046 (published Aug. 3, 2006), U.S. Pub. Pat. App. No. 2008/0305219 (Dec. 11, 2008), and U.S. Pub. Pat. App. No. 2009/0285940 (published Nov. 19, 2009). While capable of imparting professional looking icing to cupcake tops, known pre-formed frosting or other edible films for placement on cakes are often gross, of unpleasant texture, and do not otherwise taste “homemade.” Thus, a need still remains for apparatus and related methods for untrained persons to produce professional looking and tasty cupcakes.

### SUMMARY OF THE INVENTION

In view of the foregoing, it is an object of the present invention to disclose apparatus and related methods of producing professional looking and tasting cupcakes. In one embodiment, the disclosed apparatus are novel and pre-made butter cream frosting stickers for standard cupcakes. In a preferred mode of operation, the frosting sticker is applied to the top of a baked cupcake and allowed to set. In one mode of preparation, the sticker is prepared via piping frosting into a disk on a pan and freezing the disk.

### BRIEF DESCRIPTION OF THE FIGURES

The manner in which these objectives and other desirable characteristics can be obtained is explained in the following description and attached figures in which:

FIG. 1 is a perspective view of a baked cupcake 1000;

FIG. 2 is a perspective view of a pre-formed frosting sticker 2000;

FIG. 3 is and environmental view of the pre-formed frosting sticker 2000 of FIG. 2, being placed on the cupcake 1000 of FIG. 1;

FIG. 4 is the cupcake 1000 of FIG. 1 supporting the pre-formed frosting sticker 2000 of FIG. 3;

FIG. 5 is the cupcake 1000 that has been frosted by a pre-formed frosting sticker 2000 of FIG. 3; and,

FIG. 6 is an environmental view of a finger manipulating the set frosting sticker 2000 of FIG. 3 on a cupcake 1000 of FIG. 1.

### DETAILED DESCRIPTION OF THE INVENTION

Disclosed are apparatus and related methods of producing professional looking and tasting cupcakes. In one embodiment, the disclosed apparatus are novel and pre-made butter cream frosting stickers for standard cupcakes. In a preferred mode of operation, the frosting sticker is applied to the top of a baked cupcake and allowed to set. In one mode of preparation, the sticker is prepared via piping frosting into a disk on a pan and freezing the disk. Other details and aspects of the disclosed apparatus and methods are set forth with reference to the figures.

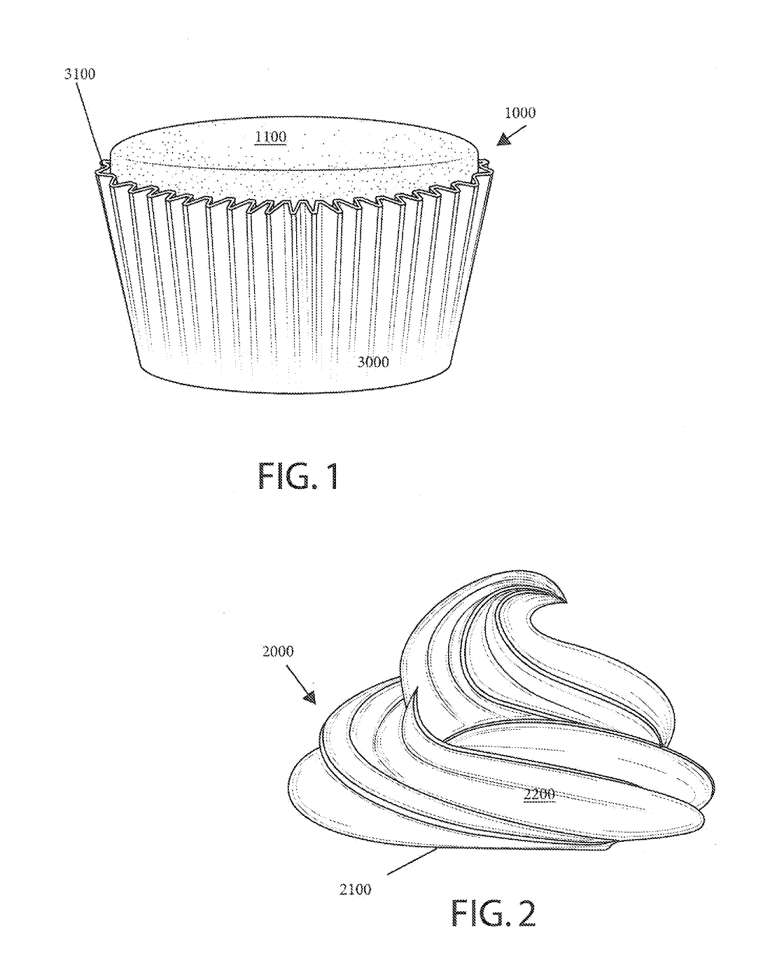

FIG. 1 is a perspective view of a baked cupcake 1000. As shown, the cupcake 1000 is formed within a paper cup 3000, wherein a top surface 1100 of the cupcake is exposed at or above the brim 3100 of the paper cup 3000. While the depicted cupcake 1000 features a top surface 1100 that is flat, other cupcakes (not shown) may feature various forms of a top surface like a bulged concave or sunken convex surface.

The depicted cupcake 1000 may be of any flavor or recipe known to those of skill in the art. In one embodiment, the cupcakes might be vanilla flavored. Ingredients for twenty four standard sized vanilla cupcakes include: three cups of flour; one and a half teaspoons of baking powder; three-quarters teaspoon salt; twelve tablespoons of butter at room temperature; one and a half cups of sugar; four large eggs; and two teaspoons of vanilla extract; one and a quarter cups of milk. Suitably, the vanilla cupcake may be prepared by: lining a cupcake pan with paper cups; mixing the flower baking powder and salt in a first bowl; mixing the butter and sugar in a second bowl until fluffy; adding eggs, one at a time, to the butter and sugar in the second bowl; mixing in the vanilla extract with the contents of the second bowl; adding the milk and contents of the first bowl to the second bowl; dividing the batter among the paper cups; and baking the batter in the paper cups at three-hundred and fifty degrees for 20 minutes.

FIG. 2 is a perspective view of a pre-formed frosting sticker 2000. As shown, the frosting sticker 2000 is defined by a rigid disk with a flat bottom 2100 and a decorative top 2200 that is defined by artwork or other style.

As shown, the top 2200 is swirl shape, however, many different shapes of the top may be known to those of skill in the art.

The depicted frosting sticker 2000 may be of any flavor or recipe known to those of skill in the art. In a preferred embodiment, the frosting is of a butter cream type. For instance the frosting sticker might comprise the following ingredients for nine cups of frosting: two and a half cups of sugar; ten large egg whites; four cups of butter; and two teaspoons of vanilla extract. Preferably, the frosting may be prepared by: placing the sugar and egg whites in a first bowl and mixing the ingredients with an electric mixer; setting the bowl of gently simmering water and dissolving the sugar in the egg whites while whisking; whisking the mixture with an electric mixer on high speed for about ten minutes; adding the butter and beating the mixture until incorporated; beating the vanilla into the mixture; finally, beating the mixture with an electric mixer with a paddle attachment at low speed for about five minutes.

A preferred embodiment for vanilla frosting stickers 2000 uses two cups of salted butter, three and a half cups of sifted powdered sugar, two tablespoons of heavy cream, a half tablespoon of vanilla extract and a half teaspoon of salt. All ingredients should be at room temperature.

Preferably the frosting may be prepared by whipping the butter until smooth in a standard mixer on low and adding sugar in thirds until combined; then adding the salt and vanilla and mixing for about fifteen seconds; and adding the cream and mixing the ingredients on medium until there is a smooth consistency to the mixture.

Referring to FIG. 2, a butter cream frosting sticker 2000 may generally be constructed by placing the butter cream frosting into a bag with a decorating tip and forcing the frosting through the tip to create the desired shape of the top 2200 and bottom 2100 of the frosting disk 2000. The tip may be a round tip, leaf tip, flower tip, ruffle tip, basket weave tip, rose tip, specialty tip, star tip, or the like. Those of skill in the art will know well the type of tip used.

The frosting disks 2000 can be formed in an unlimited number of shapes and sizes. For a mini cupcake, the disk 2000 be approximately between two and three centimeters in diameter and approximately two to three and a half centimeters in height. A standard cupcake sticker will be about five to seven centimeters in diameter and between two and four centimeters tall. A jumbo disk 2000 will be approximately seven to nine centimeters in diameter and three to five centimeters in height. The ratio of diameter to height increases as the as the size of the cupcake increases. The larger the cupcake, the more that frosting can overwhelm the taste. For a smaller cupcake, the ratio of frosting diameter to frosting height will be about one to one. For a medium size cupcake the diameter to height ratio will be about two to one and for a jumbo size cupcake the ratio will be three to one. The preferred size diameter for a standard sized cupcake will be approximately 6.25 centimeters in diameter. At this size, the frosting will be able to accommodate the differences in sizes that can occur when cupcakes are baked by an nonprofessional baker.

The disk 2000 may suitably be prepared on a flat sheet pan and placed in a freezer. The frosting disk 2000 should set in approximately 60-90 minutes at 5°-12° F. Once the disk 2000 sets, they can be packaged or used. Discs 2000 may be kept in the freezer for six to nine months or stored in a refrigerator for up to one month. In one embodiment a non-stick coating such as wax-paper, may be positioned between the frosting and sheet pan during freezing of the frosting disk 2000. Once frozen solid, the frosting sticker 2000 is constructed.

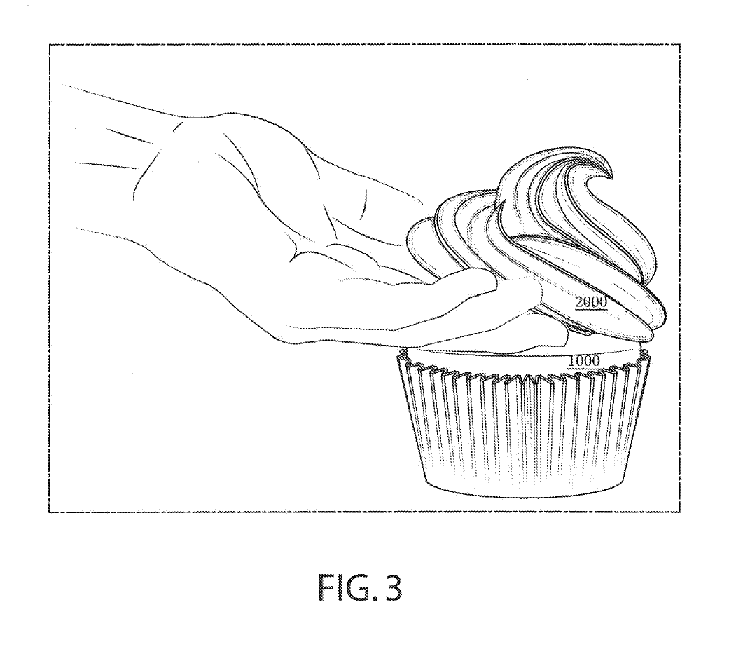

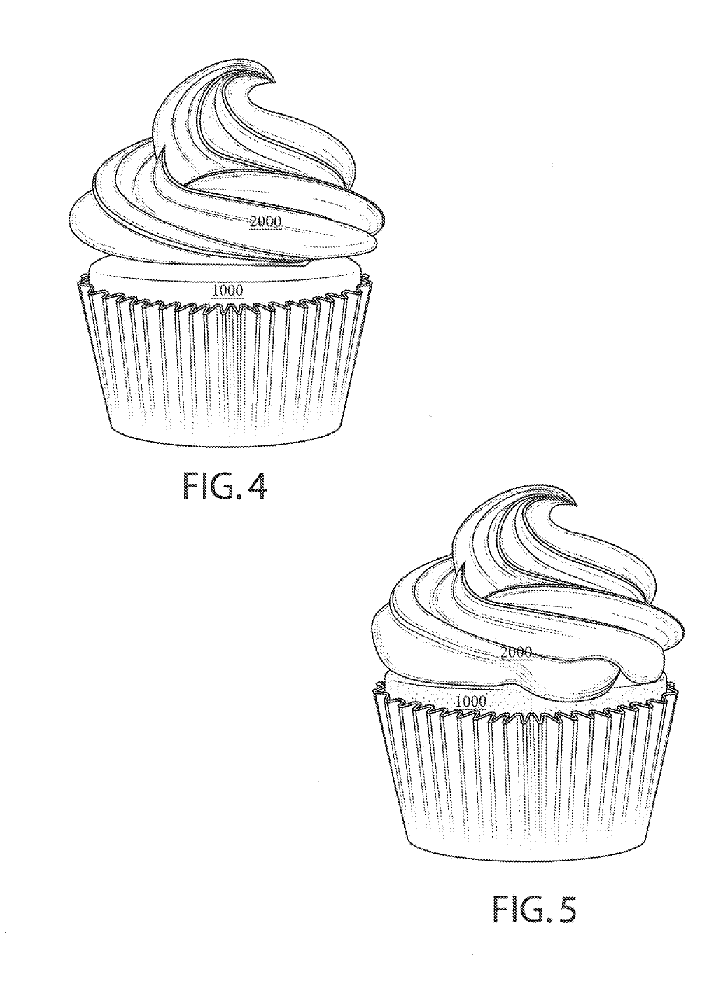

FIG. 3 is and environmental view of the pre-formed frosting sticker 2000 of FIG. 2, being placed on the cupcake 1000 of FIG. 1. FIG. 4 is a perspective view of the cupcake 1000 supporting the frosting sticker 2000. In a preferred mode, the frosting sticker is removed from the freezer in a frozen state, separated from the pan (not shown) and positioned on top 2100 of the cupcake 1000 as shown in FIG. 4.

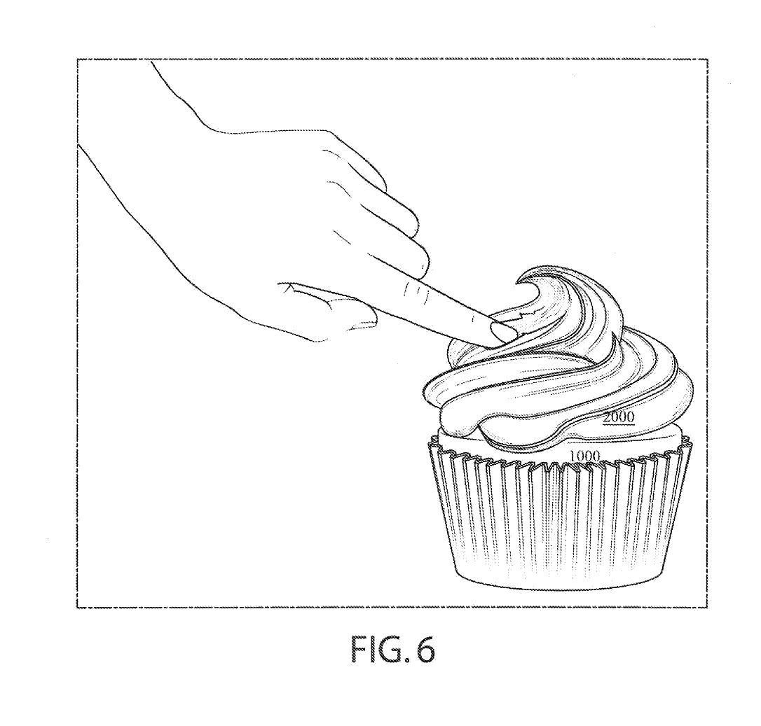

FIG. 4 is the cupcake 1000 of FIG. 1 supporting the pre-formed frosting sticker 2000 of FIG. 3. FIG. 5 is the cupcake 1000 that has been frosted by a pre-formed frosting sticker 2000 of FIG. 3. Finally, FIG. 6 is an environmental view of a finger manipulating the set frosting sticker 2000 of FIG. 3 on a cupcake 1000 of FIG. 1. Referring to FIGS. 4 through 6, a frozen frosting sticker 2000 may be placed on a cupcake 1000. To apply the frosting disk 2000 to a cupcake 1000, remove the parchment paper and immediately apply the frosting to a base. A base may be a cupcake, cookie or muffin. The frosting should be applied to the base while the frosting is still solid. Over time, the frosting will unfreeze and conform to the shape of the cupcake top 1100. In about 5-10 minutes, the frosting will be soft and creamy. Referring to FIG. 6, the frozen frosting suitably features the consistency of an ordinary butter cream frosting. One can add sprinkles, candies, etc., or one can simply eat and enjoy.

While the ideas herein disclosed has been described by means of specific embodiments and applications thereof, numerous modifications and variations could be made thereto by those skilled in the art without departing from the scope of the invention set forth in the claims.

The invention claimed is:

1. A method of preparing a cupcake comprising the steps of:
preparing cupcake batter;
baking the batter in the form of a cupcake;
preparing frosting;
freezing a disk out of the frosting; and,
placing the frozen disk on said baked batter.

2. A method of preparing a cupcake according to claim 1 wherein the disk is frozen for about sixty to ninety minutes before being placed on the baked batter.

3. A frozen disk of frosting comprising:
frosting made from any flavor or recipe; and
a removable liner.

4. A frozen disk of frosting according to claim 2 wherein said liner is made from parchment paper.

5. A frosting disk according to claim 2 where the ingredients of the frosting comprise:
about 2 cups of salted butter;
about 3.5 cups of powdered sugar;
about two tablespoons of heavy cream;
about one half tablespoon of vanilla extract; and
about one half tablespoon of salt.

6. A frosting disk according to claim 3 wherein said liner is made from parchment paper.

7. A frosting disk according to claim 2 where the diameter of the disc is between five and seven cm in diameter and between two and four cm in height.

8. A frosting disk according to claim 2 where the diameter of the disc is between seven and nine cm in diameter and between three and five cm in height.

9. A frosting disk according to claim 2 where the diameter of the disc is between two and three cm in diameter and between two and three and a half cm in height.

10. A frozen disk according to claim 2 where the disks are wrapped in a packaging, whereby the frosting disk can be sold in stores.
